(19) United States
(12) Patent Application Publication
(10) Pub. No.: US 2006/0156870 A1
(43) Pub. Date: Jul. 20, 2006

(54) Wrench extension bar with adapter

(76) Inventor: Claude Vachon, St-Nicolas (CA)

Correspondence Address: Claude Vachon, 1108 rue De La Brunante, St-Nicolas, QC, G7A 4S9, CA

(21) Appl. No.: 10/615,270

(22) Filed: Jul. 9, 2003

(51) Int. Cl. B25B 23/16

(52) U.S. Cl. 81/177.2

(57) ABSTRACT

An extension bar having at one end a generally L-shaped form of a handle, and at the opposite end of the extension bar a headblock is formed therefor receiving a wrench head, and a head portion with notches is formed thereon for receiving one of both indented openings formed thereupon top surface of an adapter being configured therefor receiving a straight wrench, and which is capable of rotating to allow the wrench to loosen or tighten nuts or bolts head in locations where are difficult to reach with the wrench.

### BACKGROUND OF THE INVENTION

1. Field of the Invention

The present invention relates to an extension bar having at one end a generally L-shaped form of a handle, and which at the opposite end of the extension bar is mounted an adapter being configured therefor receiving a straight wrench, and which is capable of rotating to allow the wrench to loosen or tighten nuts or bolts head in locations where are difficult to reach with a wrench.

2. Description of the Related Art

A search of prior art records has unveiled the following patents:
1. FR 2,808,716 issued in 2001 to Chaffher;
2. CA 1,275,184 issued in 1990 to Moetteli;
3. CA 1,121,191 issued in 1982 to Becker;
4. CA 2,152,661 issued in 1999 to Leonhardt;
5. CA 275,066 issued in 1937 to Waters;
6. WO 8,502,574 issued in 1985 to Moetteli;
7. U.S. Pat. No. 6,138,533 issued in 2000 to Turtle;
8. U.S. Pat. No. 6,112,625 issued in 2000 to Turtle;
9. U.S. Pat. No. 6,033,081 issued in 2000 to Huang;
10. U.S. Pat. No. 5,148,724 issued in 1992 to Rexford; and
11. U.S. Pat. No. 4,350,064 issued in 1982 to Markle.

As can be seen the patents mentioned above are probably the most relevant.

It is, accordingly, a general object of this invention is therefore to provide an extension bar having at one end a generally L-shaped form of a handle with an adapter being configured therefor receiving a straight wrench, and which is capable of rotating to allow the wrench to loosen or tighten nuts or bolts head in locations where are difficult to reach with a wrench.

### SUMMARY OF THE INVENTION

In accordance with the teachings of the present invention, there is disclosed an extension bar having at one end a generally L-shaped form of a handle, and which at the opposite end of the extension bar a headblock is formed therefor receiving a wrench head, and a head portion with notches is formed therefor receiving one of both intended openings formed thereupon top surface of an adapter being configured therefor receiving a straight wrench, and which is capable of rotating to allow the wrench to loosen or tighten nuts or bolts head in locations where are difficult to reach with a wrench.

### BRIEF DESCRIPTION OF THE SEVERAL VIEWS OF THE DRAWING(S)

FIG. 1 is a perspective view of an extension bar on which is mounted an adapter for receiving a straight wrench—as shown in phantom lines.

FIG. 2 is a bottom view of the FIG. 1.

FIG. 3 is a rear view of the adapter corresponding to FIG. 1.

FIG. 4 is a bottom view of the FIG. 3.

FIG. 5a is a top perspective view of the adapter with a straight wrench.

FIG. 5b is a bottom view of the FIG. 5a.

FIG. 6 is an exploded view of the extension bar with adapter.

FIG. 7 is a perspective view of the adapter capable of receiving a ratchet handle—as shown in phantom lines.

FIG. 8 is a side view of the extension bar with adapter in motion.

FIG. 9 is an other fastening means for adapting a wrench to the same extension bar.

FIG. 10 is a bottom perspective view of the FIG. 9.

FIG. 11 is an exploded view of the FIG. 9.

### DETAILED DESCRIPTION OF THE INVENTION

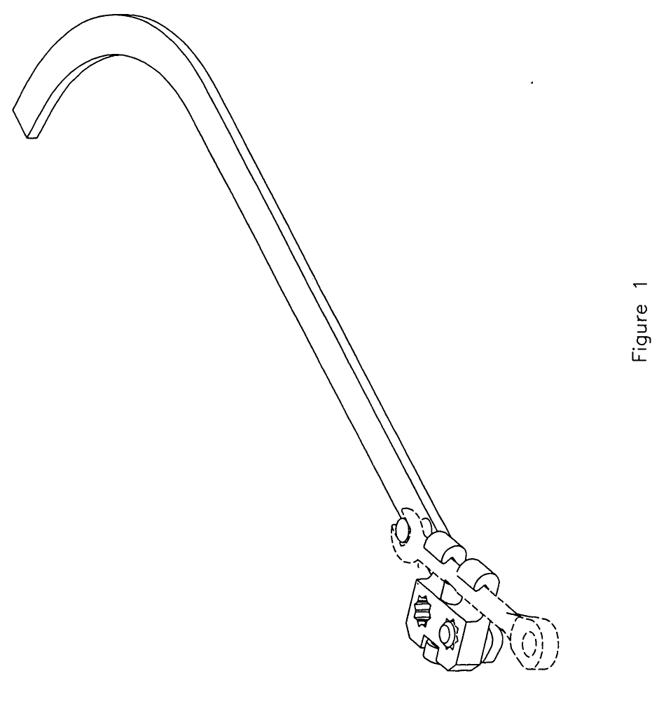

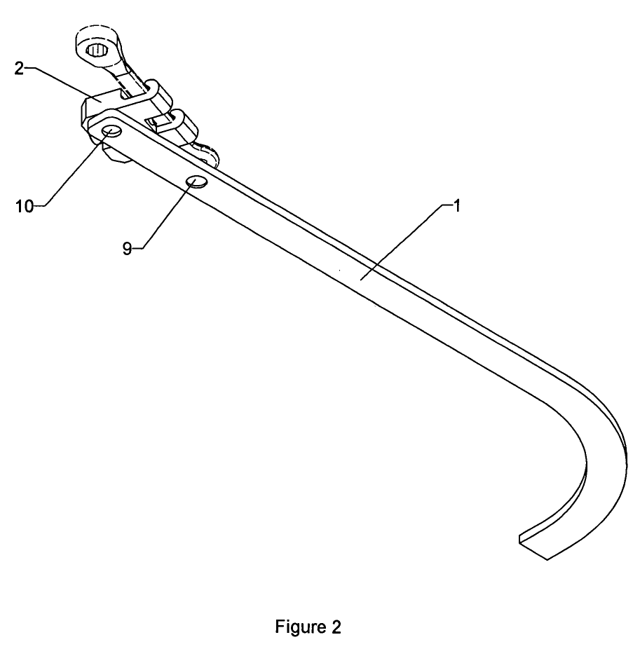

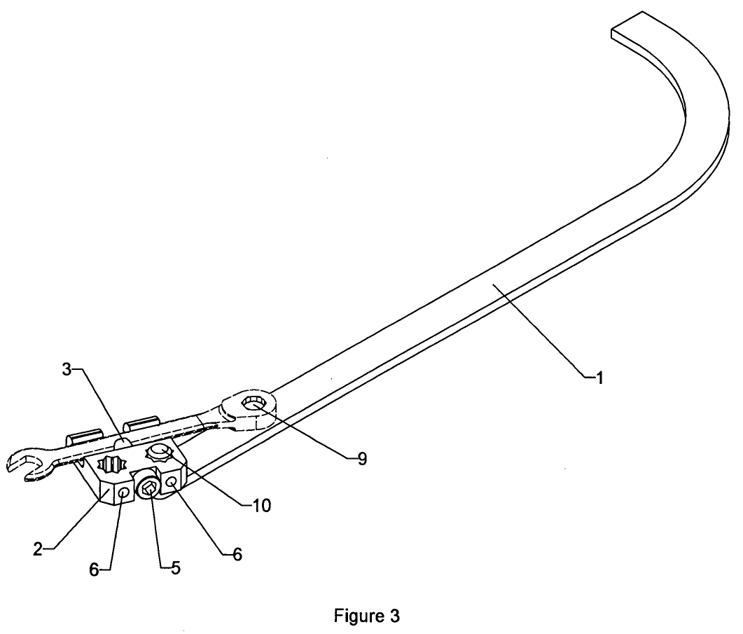

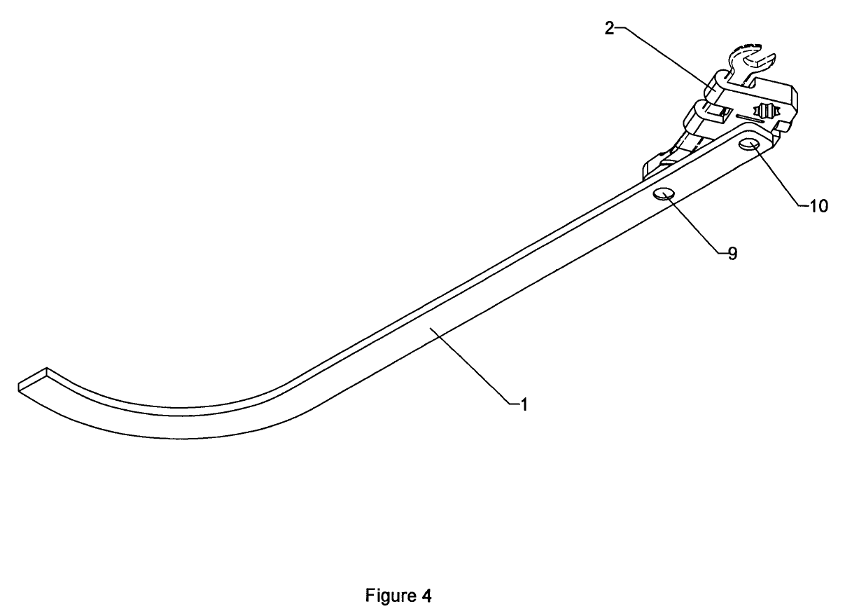

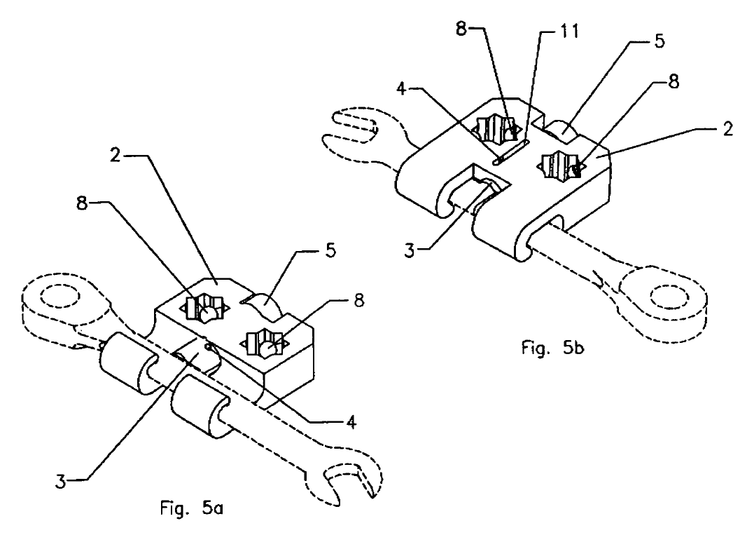

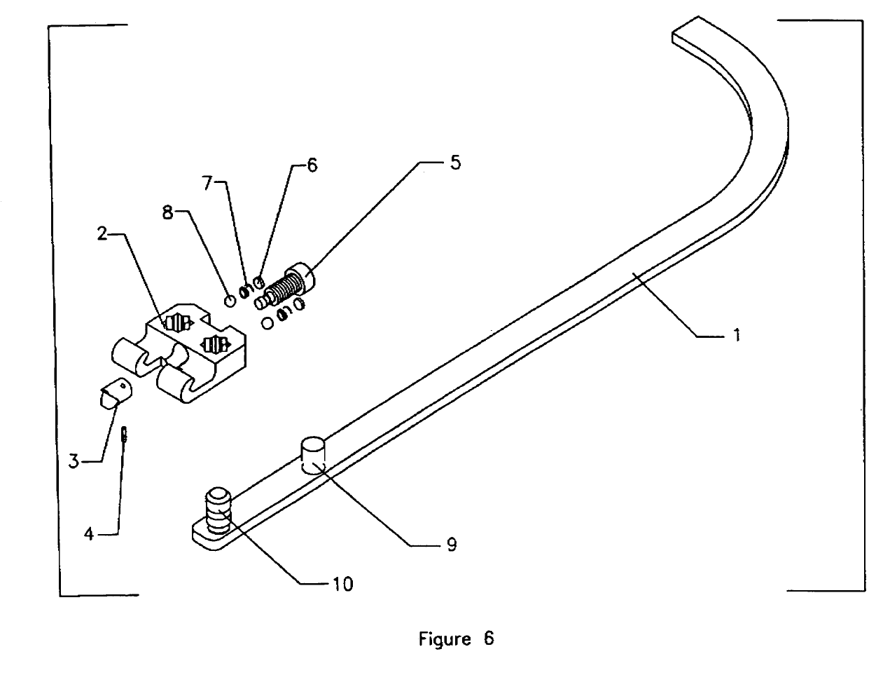

Referring now to FIGS. 1 to 5b and 6, there is illustrated an extension bar (1) having at one end a generally L-shaped form of a handle, and at the opposite end of the extension bar a headblock (9) is formed therefor receiving a wrench head, and a head portion (10) with notches is formed nearby the headblock (9) thereon the extension bar (1) for receiving one of both indented openings formed thereupon flat portion of an adapter (2) having two curved end portions therefor receiving the straight wrench that is tightened with a concave facing of a slidable member (3) therefor blocking the wrench in position.

The adapter (2) includes an opening formed between each curved end portion therefor receiving a backward end of the slidable member (3) having holes an opening formed at the opposite end therefor receiving a leg portion of a bolt (5) to be engaged therein hole of the backward end of the slidable member (3) therefor adjusting the wrench according its weight, a locking pin (4) passing therethrough hole formed thereupon top surface of the slidable member (3) for preventing the rotation of the slidable member (3) and therethrough a slot (11) formed underneath the adapter (2) to be blocked therein a groove formed with leg portion of the bolt (5), two apertures which are formed at one end of the adapter (2) therefor receiving each compression spring (7) which are pressed against each ball bearing (8) being mounted therein each indended opening formed thereupon flat portion of the adapter (2) therefor blocking the adapter (2) thereon the head portion (10), and which the compression springs (7) are blocked in place thereby a cap piece (6).

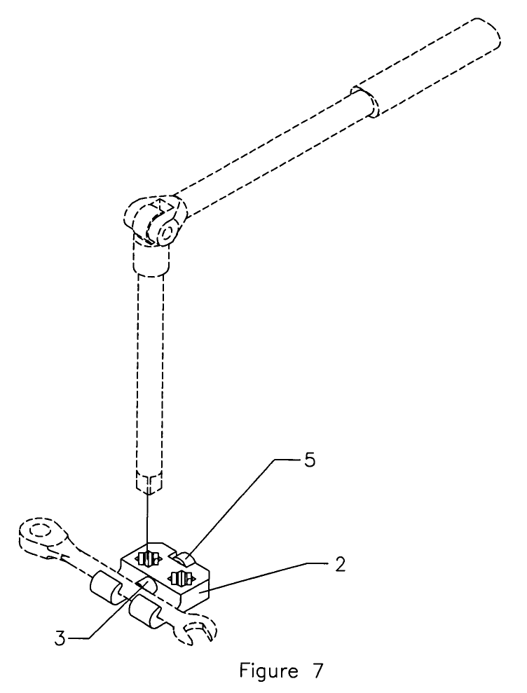

As illustrated in FIG. 7, it is shown the adapter (2) that is manually removable from the extension bar (1) to be attached to a ratchet wrench handle—as shown in phantom lines.

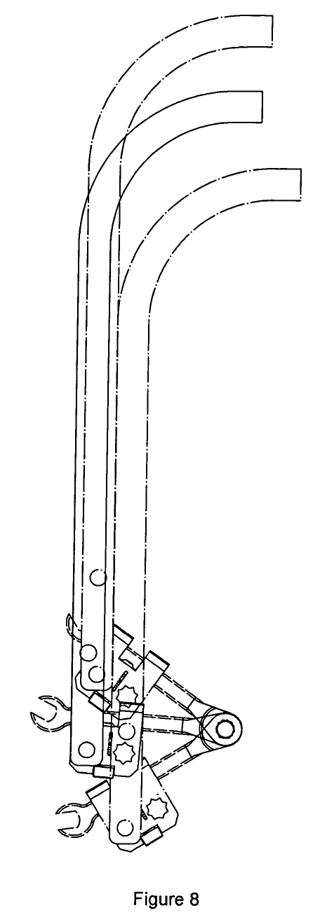

As illustrated in FIG. 8, it is shown the extension bar (1) with adapter (2) in motion.

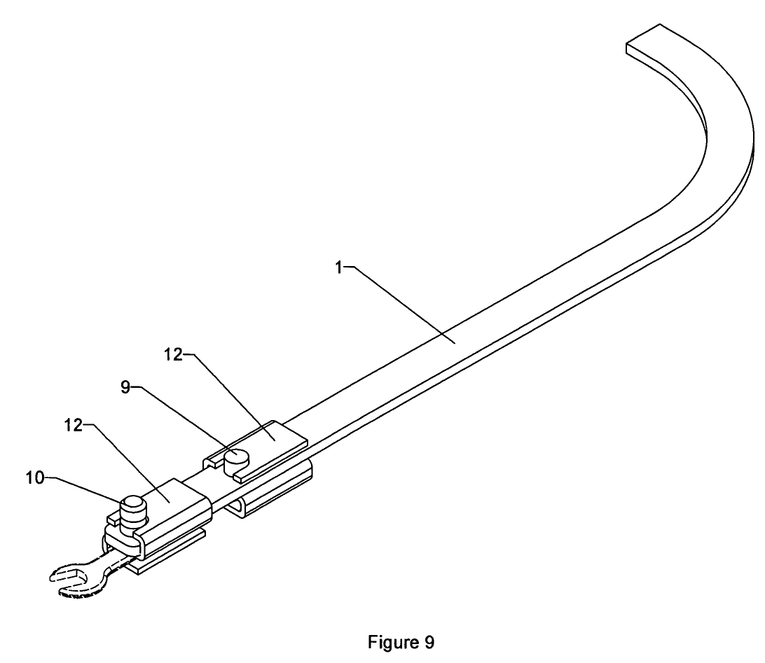

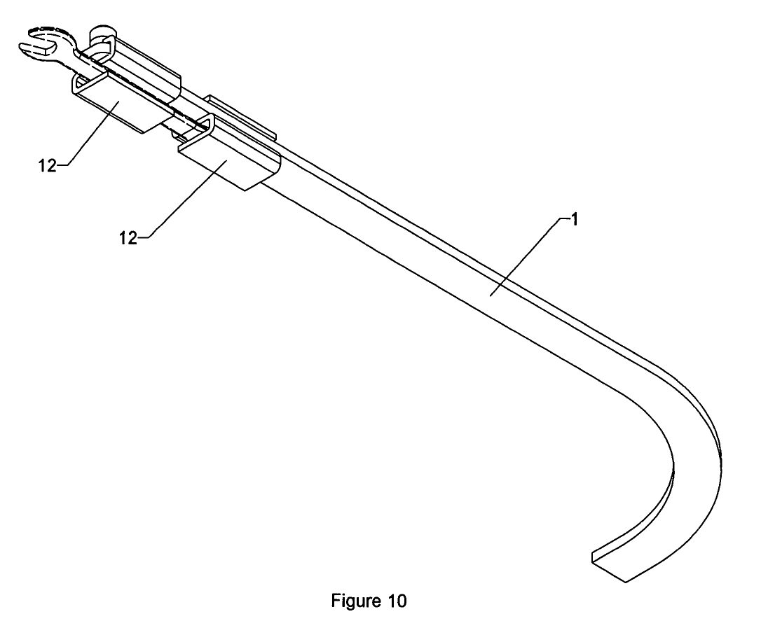

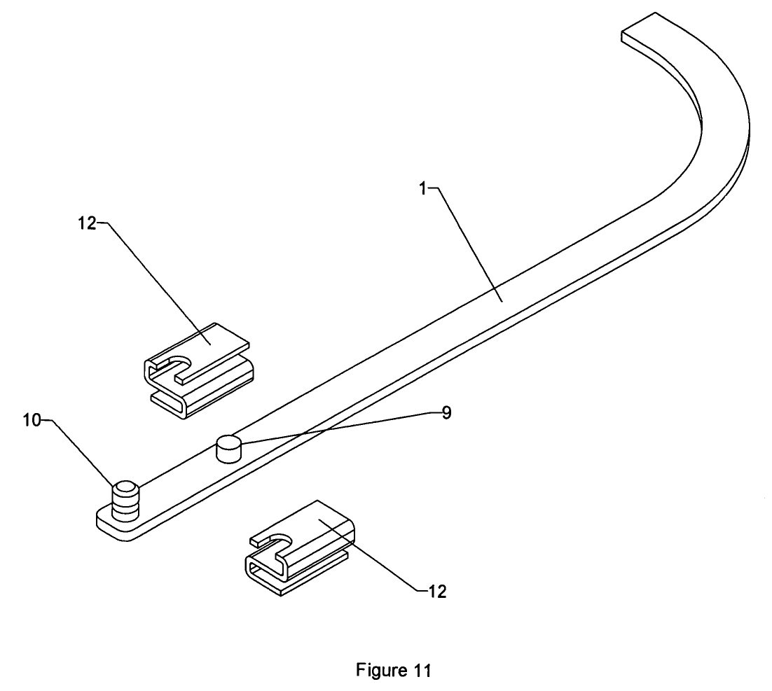

As shown in FIGS. 9 to 11, there is illustrated an other fastening means to adapt a wrench to the extension bar (1) of the present invention, which comprises two members portions (12) having each an inverted C-shaped opening formed thereon each top surface for engaging head portion (10) with notches and headblock (9) which are formed onto the extension bar (1).

A wrench—as shown in phantom lines—is installed into each S-shaped opening extending along each side of each member portion (12), and which the first member portion (12) is inverted compared to the second member portion (12) for engaging and blocking the wrench.

It is to be understood that the present invention is not limited to the sole embodiment described above but encompasses any and all embodiments within the scope of the following claims.

### DRAWING REFERENCE NUMERALS

1: Extension bar
2: Adapter
3: Slidable member
4: Locking pin
5: Bolt
6: Cap piece
7: Compression spring
8: Ball bearing
9: Headblock
10: Head portion
11: Slot

The embodiments of the invention for which an exclusive property or privilege is claimed, are defined as follows:

I claim:

1-5. (canceled)

1. A wrench handle, said wrench handle comprising:
an extension bar having at one end a generally L-shaped form of a handle;
a headblock formed at the opposite end of the extension bar therefor receiving a wrench head;
a head portion with notches formed nearby the headblock thereon said extension bar for receiving one of both indented openings formed thereupon flat portion of an adapter having two curved end portions therefor receiving the straight wrench that is tightened with a concave facing of a slidable member therefor blocking the wrench in position:
said adapter includes an opening formed between each said curved end portion therefor receiving a backward end of said slidable member having hole;
an opening formed at the opposite end therefor receiving a leg portion of a bolt to be engaged therein hole of the backward end of said slidable member therefor adjusting the wrench according its weight;
a locking pin passing therethrough hole formed thereupon top surface of said slidable member for preventing the rotation of said slidable member and therethrough, a slot formed underneath said adapter to be blocked therein a groove formed with leg portion of said bolt
two apertures formed at one end of said adapter therefor receiving two compression springs which each compression spring is pressed against a ball bearing being mounted therein each said indented opening formed thereupon, flat portion of said adapter for blocking said adapter thereon said head portion, and which said compression springs are blocked in place thereby a can piece; and
said adapter is manually removable from said extension bar to be attached to a ratchet wrench handle.

2. An other fastening means to adapt a wrench to the extension bar which comprising:
two members portions having each an inverted C-shaped opening formed thereon each top surface for engaging head portion with notches and headblock formed onto said extension bar; and
a wrench is installed into each S-shaped opening extending along each side of each said member portion, and which the first member portion is inverted compared to the second member portion for engaging and blocking the wrench.
